(19) United States
(12) Patent Application Publication
(10) Pub. No.: US 2013/0018580 A1
(43) Pub. Date: Jan. 17, 2013

(54) Creating a Graphic Display Based on Movement

(71) Applicant: Maria Scileppi, Chicago, IL (US)

(72) Inventor: Maria Scileppi, Chicago, IL (US)

(21) Appl. No.: 13/182,673

(22) Filed: Jul. 14, 2011

(51) Int. Cl. G01C 21/00

(52) U.S. Cl. 701/454; 701/468

(57) ABSTRACT

A method for creating a graphic display using the changing GPS coordinates of a moving object, such as a moving person. The method obtains the GPS coordinates from a tracking device or a mobile application and stores them in a data set. The speed and course of each data set is calculated to form a path and is assigned different indicia, such as a symbol and a color. The method displays the path of the data set to form the graphic display.

### BACKGROUND OF THE INVENTION

1. Field of the Invention

The present invention relates to a method for creating a graphic display based on the changing location of a moving object, such as a moving person.

2. Description of the Prior Art

Many computing applications today, such as computer games and multimedia applications, track a person's movement and display that movement on an audiovisual display.

U.S. patent publication 2010/0295771 discloses a method to control a display object, such as an avatar representing a person. A capture device captures images or frames of a body part at different times. Based on these images or frames, the velocities and blend velocity of the body parts can be determined. The display object can then be controlled or moved in accordance with the blend velocity. Although patent publication '771 discloses a way to track and display a user's movement using a capture device, it does not disclose how to track the specific latitude and longitude location of a particular user, assign indicia to that location, and display that location.

U.S. Pat. No. 7,834,846 and 7,259,747 disclose a device which allows interaction between a person and a computer display system using the person's movement and position as input to the computer. The computer generates a display, which can include objects or shapes that respond to the user's position and movement. Although patents '846 and '747 disclose a device that tracks and displays a user's movement, it does not disclose how to track the specific latitude and longitude location of a particular user, assign indicia to that location, and display that location.

U.S. Pat. No. 7,625,316 discloses a system for monitoring movement of a user while performing exercise. The system includes a position monitor, a receiver and a display generator. The position monitor generates positional information describing a movement of a user and wirelessly transmits that information to a remote component. The receiver receives the positional information and communicates that information to the display generator. The display generator provides sensory feedback relating to the performance of the exercise by the user. Although patent '316 discloses a system that tracks user movement during exercise, it does not disclose how to track the specific latitude and longitude location of a particular user, assign indicia to that location, and display that location.

U.S. Pat. No. 7,463,270 discloses a system and method for use in controlling movement of a virtual image version of a physical object. The physical object can be placed on or near a display surface which senses the presence of the object and displays a virtual image of that object. The virtual image moves along with the movement of the physical object. Although patent '270 discloses a system that tracks an object's movement and displays that movement, it does not disclose how to track the specific latitude and longitude location of a particular object, assign indicia to that location, and display that location.

U.S. Pat. No. 6,580,811 discloses an apparatus and method for sensing a person's facial movements, features, and characteristics to generate and animate an avatar image based on facial sensing. Patent '811 does not disclose how to track the specific latitude and longitude location of a particular object, assign indicia to that location, and display that location.

U.S. Pat. No. 5,913,727 discloses an interactive movement and contact simulation game in which a player and a three dimensional computer generated image interact in simulated physical contact. Patent '727 does not disclose how to track the specific latitude and longitude location of a particular object, assign indicia to that location, and display that location.

The prior art to date does not disclose a method for tracking the global positioning system (GPS) coordinates of a user or object and displaying the changing coordinates in various indicia. None of the prior art can be combined to suggest tracking movement via GPS. There is no teaching, suggestion, or motivation that would have enabled a person of ordinary skill in the art to modify any prior art to use GPS coordinates for tracking and displaying movement as art.

It is a primary object of the present invention to create a visual work of art.

Another object of the present invention is to track the GPS coordinates of a user's or object's movements and display the changing coordinates of that user or object as a work of art.

### SUMMARY OF THE INVENTION

Disclosed herein is a method for creating a graphic display based on an object's movement. The movement of a user is determined by obtaining the GPS coordinates of the object stored in either a tracking device or a mobile application. These GPS coordinates are the latitude and longitude of the moving objects and are stored in a data set which can be retrieved to create the graphic display.

Each data set of coordinates is used to determine that user's velocity and course. Indicia, such as date, shape, color, and name, are assigned to each set of coordinates and are used to graphically display that user's movement, using the calculated velocity and course, through time.

### BRIEF DESCRIPTION OF THE DRAWINGS

The systems, methods, and computer readable media for controlling display objects in accordance with this specification are further described with reference to the accompanying drawings in which:

FIG. 1 depicts a flow diagram of the system;

FIG. 2 depicts a flow diagram of a method for importing the data set of GPS coordinates;

FIG. 3 depicts a flow diagram of a method for displaying the data set;

FIG. 4 depicts a still image of a graphic display of the data set of GPS coordinates;

FIG. 5 depicts a still image of a graphic display of the data set of GPS coordinates.

### DETAILED DESCRIPTION OF THE ILLUSTRATED EMBODIMENTS

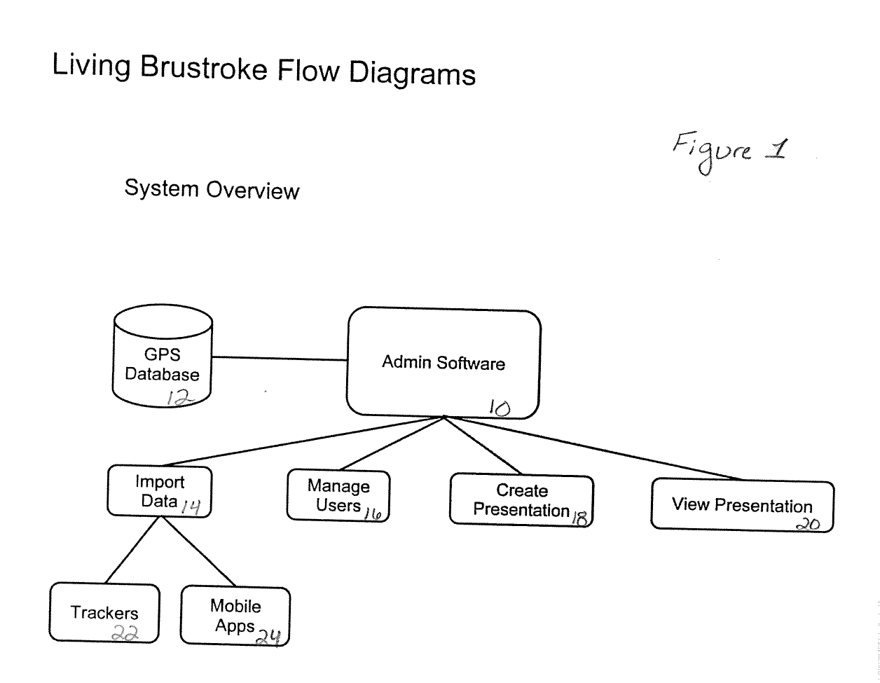

Referring to FIG. 1, the illustrated embodiment comprises administrative software at 10, which imports data at 14, manages users at 16, creates a presentation at 18, and displays the presentation at 20 by accessing a GPS database at 12. The software 10 imports data 14, which comprises a plurality of locations of a moving object, by using a tracking device 22 or a mobile application 24 and saves these locations in a data set. The plurality of locations corresponds to the GPS coordinates, the latitude and longitude, of the moving object.

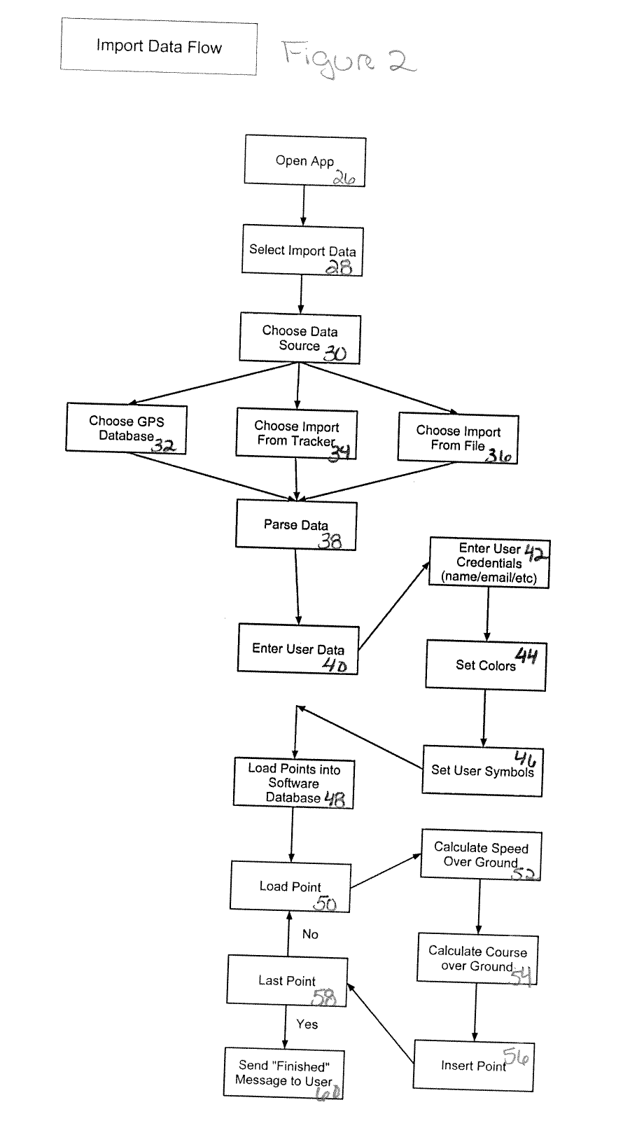

FIG. 2 depicts a flow diagram of a method application for importing data. The user opens the application 26 and selects data to import 28. The user imports data 28 by choosing the data source 30 from either a GPS database, a tracker 34, or a file 36. The data is parsed 38 by entering user data 40. When entering user data 40, the user assigns indicia to each of the plurality of locations, which comprises entering user credentials, such as name and email, at 42, setting colors at 44, and setting user symbols at 46. The points set in entering user data 40 are loaded and saved into the software database 48. The application 26 then determines a plurality of velocities and courses of the moving object from one location to the next location. Each point in the software database 48 is loaded at 50 where the velocity is calculated over ground 52 by calculating the distance over time between the current point and the previous point, the course is calculated over ground 54 by calculating a line between the current point and the previous point, and the point is inserted 56. If the point inserted 56 is not the last point 58, then the process repeats and a new point is loaded at 50. Otherwise if the point inserted at 56 is the last point 58, then a “Finished” message is sent to the user at 60.

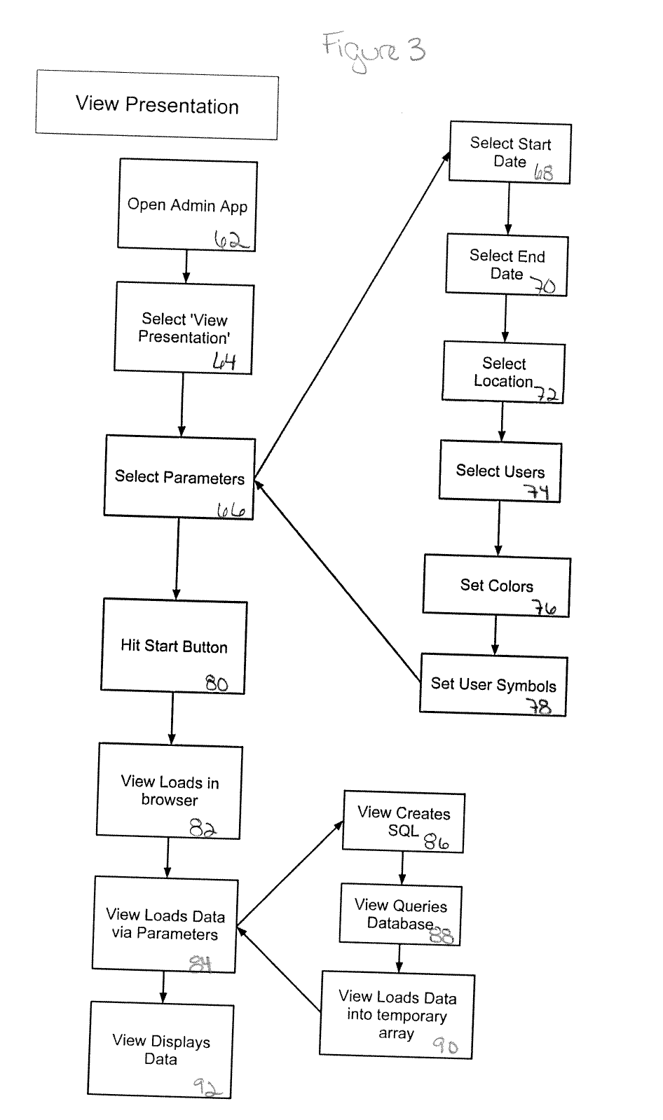

FIG. 3 depicts a flow diagram of a method application for displaying the data set parsed in the method application for importing data in FIG. 2. The user opens the application 62 and selects “View Presentation” 64. The user selects the parameters 66 by selecting the start date 68, selecting the end date 70, selecting the location 72, selecting the users 74, setting the colors 76, and setting the user symbols 78. In an alternate embodiment, the location 72 is selected by the latitude and longitude of the data set within the defined time frame. The user then pushes the start button 80 and the application loads the display in the browser 82. The display loads the data via parameters 84 by creating the SQL, the standard language for accessing databases, at 86, querying the database at 88, and loading the data into a temporary array 90. The application then displays the data 92 of the moving object, which comprises displaying the symbol, in a particular color, for each location in the data set at the rate of the corresponding velocity in the data set. A showing of the variation of speed within a data set may be obtained by enlarging the size of the symbol responsive to increases in speed of the moving object.

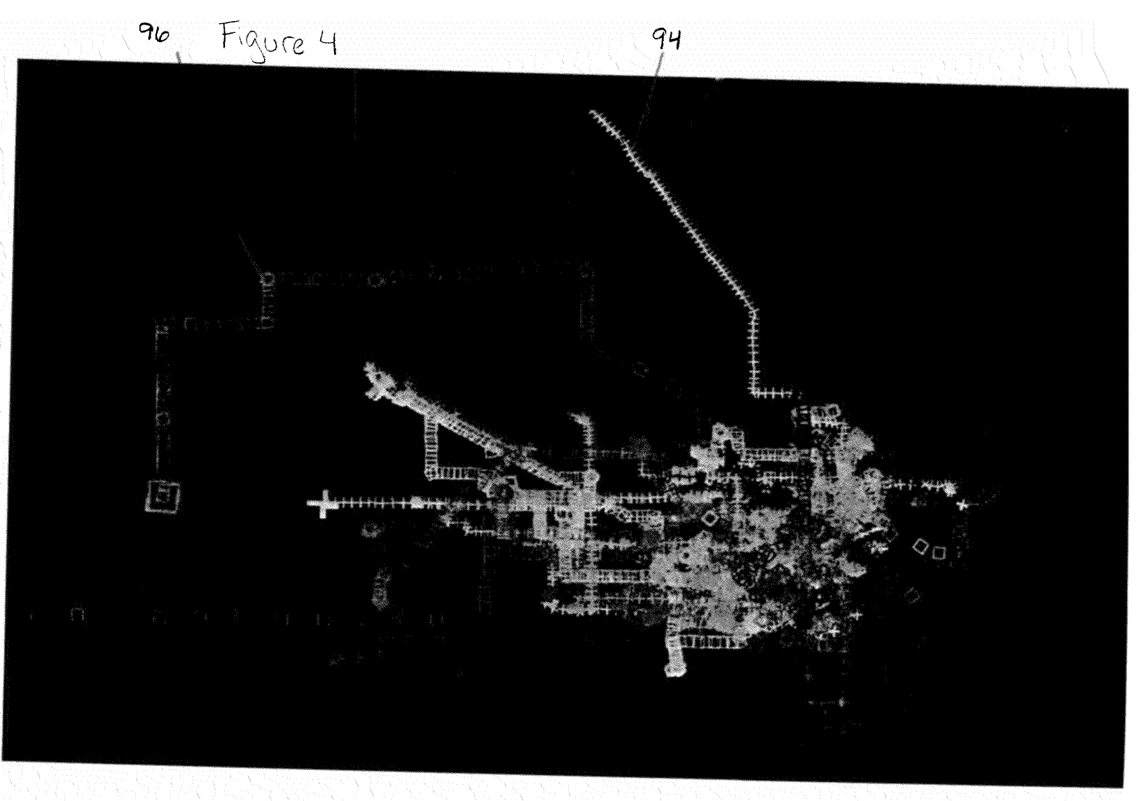

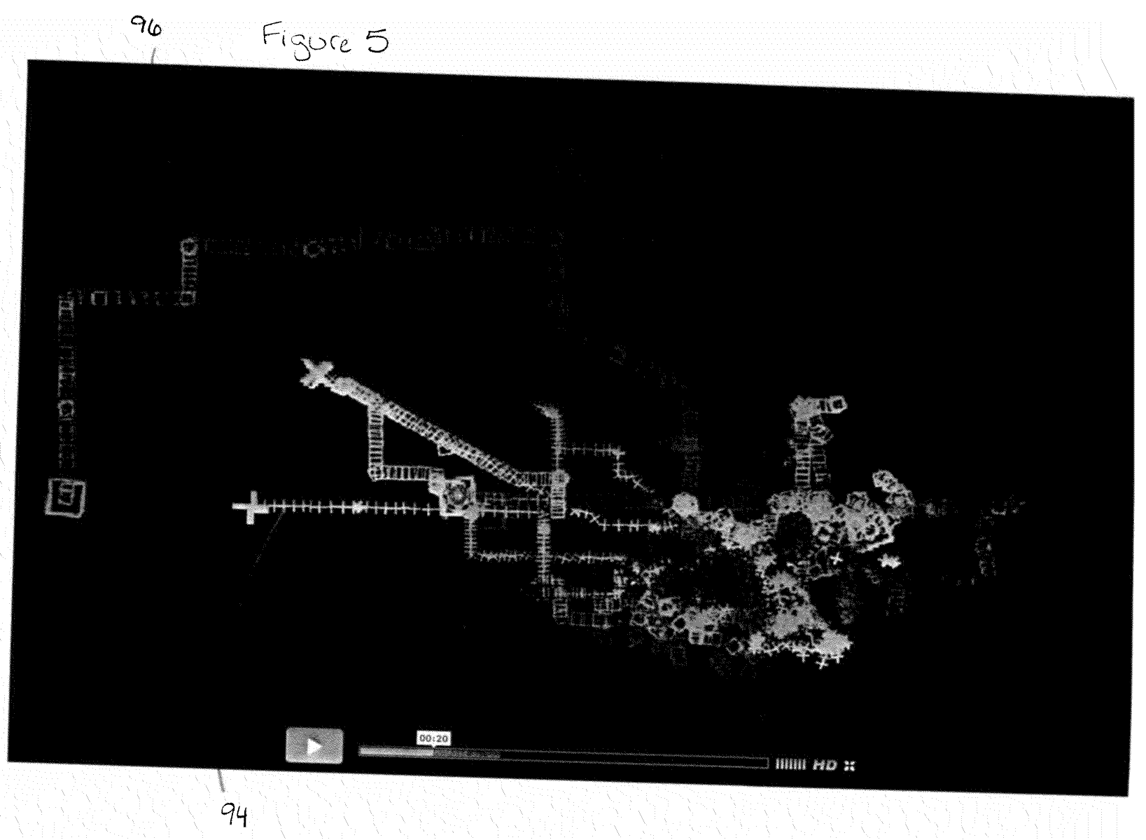

FIGS. 4 and 5 depict a still image of a graphic display of the data set of GPS coordinates. The changing location of each data point in the data set creates a path and each path is represented by different indicia, such as a symbol and color. In the illustrated embodiment, the path of data set 94 is represented by a plus symbol and a light blue color. The path of data set 96 is represented by a square symbol and a purple color. The trace of the paths of the data sets forms the graphic display image.

The method for creating a graphic display can be stored on a computer readable medium as computer executable instructions. The method runs on a systems comprising of a computing device and a display. The computing device executes the computer executable instructions contained in the computer readable medium and the display displays the graphic image generated by the method of the present invention.

The foregoing description of an illustrated embodiment of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

What is claimed is:

1. A method for creating a graphic display, the method comprising:
a. determining a plurality of locations of a moving object and saving the locations in a data set;
b. assigning an indicia to each of the plurality of locations and saving the indicia in a data set;
c. determining a plurality of velocities of the moving object from one location to the next location and saving the velocities in a data set;
d. determining a plurality of courses of the moving object from one location to the next location and saving the courses in a data set; and
e. displaying the data set in accordance with the locations, velocities, courses, and indicia of the moving object.

2. The method of claim 1, wherein the plurality of locations of the moving object are GPS coordinates of the moving object stored in one of a tracking device and a mobile application.

3. The method of claim 2, wherein the GPS coordinates are the latitude and longitude of the moving object.

4. The method of claim 1, wherein the plurality of velocities are determined by calculating distance over time between the current location and the previous location of the moving object.

5. The method of claim 1, wherein the plurality of courses are determined by calculating a line between the current location and the previous location of the moving object.

6. The method of claim 1, wherein displaying the data set of the moving object comprises displaying a shape, in a particular color, for each location in the data set at the rate of the corresponding velocity in the data set.

7. A computer readable medium having stored thereon computer executable instructions for creating a graphic display, comprising:
a. determining a plurality of locations of a moving object and saving the locations in a data set;
b. assigning an indicia to each of the plurality of locations and saving the indicia in a data set;
c. determining a plurality of velocities of the moving object from one location to the next location and saving the velocities in a data set;
d. determining a plurality of courses of the moving object from one location to the next location and saving the courses in a data set; and
e. displaying the data set in accordance with the locations, velocities, courses, and indicia of the moving object.

8. The computer readable medium of claim 7, wherein the plurality of locations of the moving object are GPS coordinates of the moving object stored in one of a tracking device and a mobile application.

9. The computer readable medium of claim 8, wherein the GPS coordinates are the latitude and longitude of the moving object.

10. The computer readable medium of claim 7, wherein the plurality of velocities are determined by calculating distance over time between the current location and the previous location of the moving object.

11. The computer readable medium of claim 7 wherein the plurality of courses are determined by calculating a line between the current location and the previous location of the moving object.

12. The computer readable medium of claim 7 wherein displaying the data set of the moving object comprises displaying a shape, in a particular color, for each location in the data set at the rate of the corresponding velocity in the data set.

13. A system for creating a graphic display, the system comprising:
a. a computing device for:
i. determining a plurality of locations of a moving object and saving the locations in a data set;
ii. assigning an indicia to each of the plurality of locations and saving the indicia in a data set;
iii. determining a plurality of velocities of the moving object from one location to the next location and saving the velocities in a data set; and
iv. determining a plurality of courses from one location to the next location of the moving object and saving the courses in a data set; and
b. a display for:
i. displaying the data set in accordance with the locations, velocities, courses, and indicia of the moving object.

14. The system of claim 13, wherein the plurality of locations of the moving object are GPS coordinates of the moving object stored in one of a tracking device and a mobile application.

15. The system of claim 14, wherein the GPS coordinates are the latitude and longitude of the moving object.

16. The system of claim 13, wherein the plurality of velocities are determined by calculating distance over time between the current location and the previous location of the moving object.

17. The system of claim 13, wherein the plurality of courses are determined by calculating a line between the current location and the previous location of the moving object.

18. The system of claim 13, wherein displaying the data set of the moving object comprises displaying a shape, in a particular color, for each location in the data set at the rate of the corresponding velocity in the data set.

19. The method of claim 1, wherein the moving object is a person.

20. The method of claim 1, wherein the indicia are a name, shape, color, and date.
